(19) United States
(12) Patent Application Publication
(10) Pub. No.: US 2020/0130619 A1
(43) Pub. Date: Apr. 30, 2020

(54) VEHICLE SIDE RAIL SYSTEM

(71) Applicant: Nu-Line Products Inc., Hamilton (CA)

(72) Inventor: Gerald Harrison, Hamilton (CA)

(21) Appl. No.: 16/653,510

(22) Filed: Oct. 15, 2019

Related U.S. Application Data
(60) Provisional application No. 62/752,677, filed on Oct. 30, 2018.

(51) Int. Cl. B60R 19/42; B60R 19/12; B60R 19/38; B60R 19/18

(52) U.S. Cl. CPC B60R 19/42; B60R 19/12; B60Y 2200/144; B60R 19/18; B60R 2019/1806; B60R 19/38

(57) ABSTRACT

A vehicle side rail system is for use with a vehicle, such as a truck, having an elevated chassis and having a longitudinally extending frame member. The side rail system includes a pair of support members mounted to the frame member and extending transverse to the frame member. The support members have a plurality of openings extending therethrough. The system includes a pair of legs, each leg having a mounting portion and a depending rail portion. The mounting portions have a plurality of openings therethrough and the mounting portions are telescopically mounted to a respective support member and selectively mountable thereto. Each rail portion has a plurality of openings. Fasteners are insertable into aligned openings of respective mounting portions and support members to secure the legs to the support members at a desired location. At least one rail extends between and mounted to the rail portions. The rail is selectively mountable to the rail portions.

### CROSS-REFERENCE TO RELATED APPLICATION DATA

This application claims the benefit of and priority to Provisional U.S. Patent Application Ser. No. 62/752,677, filed Oct. 30, 2018, titled, VEHICLE SIDE RAIL SYSTEM, the disclosure of which is incorporated herein in its entirety.

### BACKGROUND

The present disclosure relates generally to vehicle side rails and in particular, to readily installed and removed side rails for trucks and the like.

Many trucks and like commercial vehicles have elevated bodies or chassis between the wheels. Accidents have occurred in which road users such as pedestrians, bicyclists and the like have been injured slipping between and under the wheels (along the sides) of these high-chassis vehicles.

Protective devices, such as gates are used between the wheels along the sides of vehicles. The gates extend from the chassis toward the ground to prevent people and objects from entering the space between the wheels. While such gates function well to prevent people and objects from entering the space between the wheels, they do have their draw backs. Mainly, these gates are fixed and do not permit ready access to the undercarriage of the vehicle for inspection, repair and maintenance.

Accordingly, there is a need for a vehicle side rail system that provides a measure of protection for road users and prevents people and objects from entering the space between the wheels. Desirably, such a system is readily installed and removed for inspection, repair and maintenance of the vehicle and the chassis undercarriage.

### SUMMARY

A vehicle side rail system is configured for use with a vehicle, such as a truck, having an elevated chassis and having a longitudinally extending horizontal frame member. The side rail system includes a pair of support members mounted to the horizontal frame member and extending transverse to the frame member. The support members have a plurality of openings extending therethrough.

A pair of legs, each have a mounting portion and a depending rail portion. The mounting portions have a plurality of openings therethrough. The mounting portions are telescopically mounted to a respective support member and selectively mountable thereto. Each rail portion has a plurality of openings.

Fasteners, such as bolts, are insertable into aligned openings of respective mounting portions and support members to secure the legs to the support members.

At least one, and preferably at least two rails extend between and mounted to the rail portions. The rails are selectively mountable to the rail portions.

In an embodiment, the support members and the mounting portions are square tubes, telescopically mountable to one another. Likewise, the rail portions can be a square tubes. In an embodiment, the mounting portions are telescopically positionable in the support members.

In an embodiment, the support members are mounted to the horizontal frame member by fasteners such as bolts, and the one or more rail is mounted to the rail portion by fasteners, such as bolts. The support members and the legs can be formed from metal.

In an embodiment the side rail system includes a bolster mounted to one of the legs.

These and other features and advantages of the present invention will be apparent from the following detailed description, in conjunction with the appended claims.

### BRIEF DESCRIPTION OF THE DRAWINGS

FIG. 1 is a side view of a truck, illustrating an embodiment of a vehicle side rail system;

FIG. 2 is an illustration of an embodiment of the system;

FIG. 3 is an illustration of the system as mounted to the truck frame;

FIG. 4 is an illustration of a rail as mounted to the system vertical support leg; and

FIG. 5 illustrates an embodiment of releasable locking system for the vertical support legs and rails.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

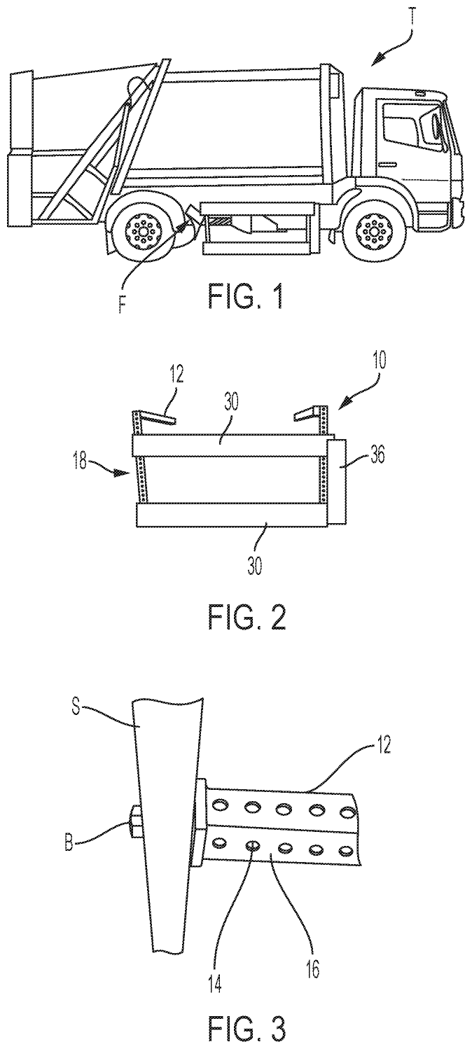

Referring now to the figures and in particular to FIG. 1 there is shown a truck T having an embodiment of a side rail system 10 installed on the truck frame F. Referring briefly to FIG. 3, the truck frame or chassis F includes a longitudinally extending horizontal frame member S onto which the side rail system 10 is installed.

Referring now to FIGS. 2 and 3, the side rail system 10 includes a pair of horizontally oriented support members 12. The support members 12 are mounted to the truck frame, and extend generally transverse, and preferably perpendicular to the frame member S to which they are mounted. In an embodiment, the support members 12 are mounted to the frame F by fasteners B, such as bolts and the like. The support members 12 include a plurality of holes or openings 14. In a present embodiment, the support members 12 are square tubular metal members, such as steel. The holes or openings 14 are located on opposing surfaces 16, such as upper and lower surfaces of the support members 12 and are aligned with one another. Members other than square tubular members can be used and are within the scope and spirit of the present disclosure.

A leg 18 is mounted to each of the support members 12. In an embodiment, the legs 18 are L-shaped having a mounting portion 20 and a depending rail portion 22. The mounting portions 20 are configured for mounting to the support members 12 in a manner to temporarily, yet securely mount the legs 18 to the support members 12. In an embodiment the mounting portions 20 have a plurality of openings 24 that correspond to and align with the openings 14 in the support members 12. In an embodiment, the mounting portions 20 have a shape that allows a telescopic sliding mounting arrangement of the mounting portions 20 to the support members 12. In the illustrated embodiment, the mounting portions 20 are positioned and telescope in the support members 12. It will be appreciated that the members 12, 20 can be configured such that the support members 12 are positioned and telescope within mounting portions 20.

As best seen in FIG. 5, the mounting portions 20 and support members 12 secure to one another by fasteners 26 that are positioned through the aligned openings 14, 24 in the support members 12 and mounting portions 20. The fasteners 26 can be, for example, pins or the like that are held in place by a cable 28, cotter pins or the like. The pins 26 lock the position of the mounting portions 20 and support members 12, but allow the pins 26 to be removed to, for example, adjust the distance the legs 18 are positioned relative to the truck chassis F. That is, the legs 18 (and thus the side rails 30) can be moved closer to or farther away from the truck chassis F, as needed. The removable pins 26 also allow ready removal of the side rails 10 for inspection, repair and maintenance of the vehicle and the chassis undercarriage, to replace or repair the side rails 10 or the like.

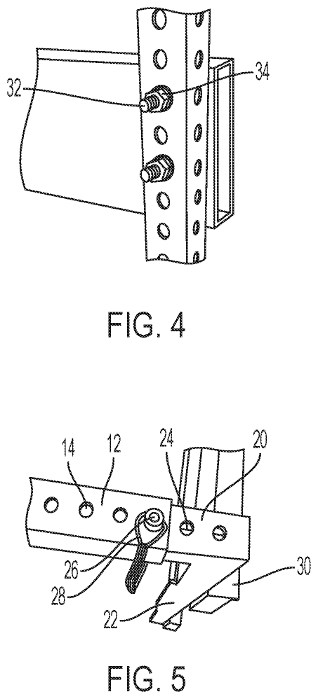

As best seen in FIGS. 2 and 4, one or more rails 30 are mounted to and between the legs 18. In the illustrated embodiment, two rails 30 are mounted to and between the legs 18, but it will be appreciated that one or more than two rails 30 can be present. In an embodiment, the rails 30 are mounted to the legs 18 by fasteners 32, such as bolts and secured by nuts 34 engaged with the bolts 32. In a present system, the rails 30 are secured to their respective legs 18 with two fasteners 32 on each side to provide a secure mounting of the rails 30 to the legs 18. Other fasteners may be used. It is preferred that the rail 30 to leg 18 fasteners 32 are of the type that can be removed to, for example, repair or replace portions of the side rails 10, as needed.

As seen in FIGS. 1 and 2, a side bolster 36 can be mounted to a side of the side rail 10. As seen in FIG. 1, the bolster 36 can extend vertically along the forward side of the side rail 10. The bolster 36 provides additional protection for road users.

In a present embodiment, the support members 12 and the legs 18 are formed from a metal, such as steel. The rails 30 can likewise be formed from metal, or the rails 30 can be formed from wood, a polymeric material and combinations thereof. Other materials for the support members 12, legs 18 and rails 30 will be recognized by those skilled in the art.

It will be appreciated that the present side rail system 10 provides a number of advantages over known systems. The present system 10 is easily installed with commonly available tools and hardware. That is, no welding, fabrication or other specialty labor is required. The system 10 can be readily removed, maintained and replaced as needed, and can be removed for access to the truck undercarriage and chassis with commonly available tools. The system 10 is also adjustable toward and away from the chassis F, and the rail 30 heights adjustable to properly fit a wide variety of needs in truck sizes, heights and the like.

It is understood the various features from any of the embodiments above are usable together with the other embodiments described herein. Further, it is understood that same or similar terminology used across the different embodiments above refers to the same or similar component, with the exception of any differences described or shown in the figures. It will also be appreciated by those skilled in the art that the relative directional terms such as sides, upper, lower, rearward, forward and the like are for explanatory purposes only and are not intended to limit the scope of the disclosure.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within the scope of the claims.

What is claimed is:

1. A vehicle side rail system for use with a vehicle having an elevated chassis and having a longitudinally extending horizontal frame member, the side rail system comprising:
a pair of support members mounted to the frame member and extending transverse to the frame member, the support members having a plurality of openings extending therethrough,
a pair of legs, each leg having a mounting portion and a depending rail portion, the mounting portions having a plurality of openings therethrough, the mounting portions telescopically mounted to a respective support member and selectively mountable thereto, each rail portion having a plurality of openings;
a pair of fasteners, each fastener insertable into aligned openings of respective mounting portions and support members to secure the legs to the support members; and
at least one rail extending between and mounted to the rail portions, the rail selectively mountable to the rail portions.

2. The side rail system of claim 1, wherein the support members are square tubes and wherein the mounting portions are square tubes, telescopically mountable to one another.

3. The side rail system of claim 2, wherein the rail portions are square tubes.

4. The side rail system of claim 1, wherein the mounting portions are telescopically positionable in the support members.

5. The side rail system of claim 1, wherein the support members are mounted to the horizontal frame member by fasteners.

6. The side rail system of claim 5, wherein the fasteners are bolts.

7. The side rail system of claim 1, wherein the at least one rail is mounted to the rail portion by fasteners.

8. The side rail system of claim 7, wherein the fasteners are bolts.

9. The side rail system of claim 1, including a bolster mounted to one of the legs.

10. The side rail system of claim 1, wherein the support members and the legs are formed from metal.
